(19) United States
(12) Patent Application Publication
(10) Pub. No.: US 2017/0263981 A1
(43) Pub. Date: Sep. 14, 2017

(54) BIPOLAR LAMINATED ALL-SOLID-STATE LITHIUM-ION RECHARGEABLE BATTERY AND METHOD FOR MANUFACTURING SAME

(71) Applicant: HITACHI METALS, LTD., Tokyo (JP)

(72) Inventor: Akira SATOU, Tokyo (JP)

(73) Assignee: HITACHI METALS, LTD., Tokyo (JP)

(21) Appl. No.: 15/451,676

(22) Filed: Mar. 7, 2017

(30) Foreign Application Priority Data
Mar. 11, 2016 (JP) 2016-047964
Dec. 1, 2016 (JP) 2016-234013

(51) Int. Cl. H01M 10/0585; H01M 10/0562; H01M 4/587; H01M 10/0525; H01M 4/485

(52) U.S. Cl. CPC H01M 10/0585; H01M 10/0525; H01M 4/485; H01M 4/587; H01M 10/0562; H01M 2004/029

(57) ABSTRACT

There is provided a bipolar laminated all-solid-state lithium-ion rechargeable battery including bipolar electrodes and solid electrolyte layers that are alternately laminated. When viewed from a lamination direction of the battery, a current collector layer of each bipolar electrode has its outer edge inside the outer edge of a positive electrode layer and a negative electrode layer of the bipolar electrode. At least one of the positive electrode layer and the negative electrode layer of each bipolar electrode is provided with at least one electrical insulating portion in an outer edge region on the surface where it is in contact with the current collector layer of the bipolar electrode. When each bipolar electrode is viewed from the lamination direction, the perspective projection of the at least one electrical insulating portion configures the entire periphery of the outer edge. The bipolar electrodes and the solid electrolyte layers form a sinter-bonded body.

### CLAIM OF PRIORITY

The present application claims priority from Japanese patent application serial no. 2016-234013 filed on Dec. 1, 2016, which further claims priority from Japanese patent application serial no. 2016-047964 filed on Mar. 11, 2016, the contents of which are hereby incorporated by reference into this application.

### FIELD OF THE INVENTION

The present invention relates to lithium-ion batteries, and more particularly to a bipolar laminated all-solid-state lithium-ion battery with a solid electrolyte for transporting lithium-ions and a method for manufacturing the bipolar laminated all-solid-state lithium-ion rechargeable battery.

### DESCRIPTION OF THE RELATED ART

Lithium-ion rechargeable batteries have a higher energy density than other rechargeable batteries and are therefore advantageous in terms of one or more of reducing battery size and weight, increasing battery capacity and increasing battery output. For this reason, lithium-ion rechargeable batteries have found increasingly wide applications not only in a small-sized electronic device such as portable personal computers and mobile phones but also in a large-sized electric equipment such as power supplies for automobiles including hybrid electric vehicles (HEVs) and electric vehicles (EVs) and power supplies for power storage.

In recent years, from the viewpoint of expanding use of lithium-ion rechargeable batteries in a large-sized electric equipment, potential applications in a high temperature environment (e.g., in an engine room and outdoors) are under consideration, and there is a need for lithium-ion rechargeable batteries that can withstand such a high temperature environment. However, conventional lithium-ion rechargeable batteries with a non-aqueous electrolyte solution are disadvantageous in terms of heat resistance and fire resistance because they typically have an upper temperature limit of approximately 60° C. and the solvent that is made up of the non-aqueous electrolyte solution is flammable.

To overcome this weak point, vigorous research for all-solid-state lithium-ion rechargeable batteries with a solid electrolyte instead of a non-aqueous electrolyte is currently under way. Since all-solid-state lithium-ion rechargeable batteries use a solid electrolyte (e.g., a solid polymer electrolyte and an inorganic electrolyte) that has an upper temperature limit over 100° C. and is nonflammable, they are capable of being used in a higher temperature environment than conventional lithium-ion rechargeable batteries using a non-aqueous electrolyte.

Lithium-ion rechargeable batteries are often designed to have a bipolar lamination structure with bipolar electrodes for a higher volume energy density. In bipolar laminated lithium-ion rechargeable batteries with a non-aqueous electrolyte solution, short-circuits between adjacent bipolar electrodes are prevented by disposing a separator between them.

In all-solid-state lithium-ion rechargeable batteries, by contrast, each solid electrolyte layer has no fluidity and therefore is capable of functioning as a separator (in other words, there is no need to dispose any separators). As a result, they have potential for an even higher volume energy density than lithium-ion rechargeable batteries with a non-aqueous electrolyte solution. However, since no separators are disposed, some ingenuity is required in the design of the lamination structure and the manufacturing method in order to prevent internal short-circuits.

For example, JP 2004-158222 A discloses a multilayer laminated battery in which a plurality of thin film solid-state lithium-ion cells are sequentially stacked and laminated on a substrate. Each cell is made up of five layers: a positive active material layer; a negative active material layer; a solid electrolyte layer disposed between the active material layers; a current collector layer disposed on the other side of the positive active material layer from the solid electrolyte layer; and another current collector layer disposed on the other side of the negative active material layer from the solid electrolyte layer. When the layers of each cell are laminated, and the cells are laminated in a plurality of stages, the width of the periphery portion of each layer is made wider in the order of the active material layers, the current collector layers, and the solid electrolyte layers. By doing so, the edge of each active material layer is laminated with the adjacent current collector layer and solid electrolyte layer, and the edge of each current collector layer is laminated with the adjacent solid electrolyte layer, thereby securing insulation between the cells.

WO 2012/020700 A1 discloses a laminated solid-state battery. The battery includes at least first and second unit cells and an internal current collector layer. Each unit cell is made up of a positive electrode layer, a solid electrolyte layer, and a negative electrode layer that are sequentially stacked. The internal current collector layer has a first side surface in contact with the positive electrode layer of the first unit cell and a second side surface in contact with the negative electrode layer of the second unit cell so as to be disposed between the first and second unit cells. The internal current collector layer contains an electron conductive material and an ion-conductively insulating specific conductive material.

Also, WO 2012/164642 A1 discloses a bipolar all-solid-state battery in which a plurality of bipolar electrodes are laminated via a solid electrolyte layer. Each bipolar electrode is made up of a current collector, a positive electrode active material layer, and a negative electrode active material layer. The positive electrode active material layer contains a positive electrode active material and is formed on one surface of the current collector, and the negative electrode active material layer contains a negative electrode active material and is formed on the other surface of the current collector. The solid electrolyte layer contains a solid electrolyte. Each electrode active material layer is formed inside the end of the current collector. Between the end of each electrode active material layer and the surface of the current collector is disposed a reinforcing layer formed on the surface of the current collector.

All-solid-state lithium-ion rechargeable batteries can be roughly classified into two types: the thin-film type and the bulk type. In terms of battery capacity, bulk type ones are advantageous since they are capable of including a greater absolute amount of electrode active material. Therefore, bulk-type all-solid-state lithium-ion rechargeable batteries are to be selected as large-capacity rechargeable batteries for large-sized electric equipment. In other words, since a bulk-type structure allows for more room for battery capacity, bulk-type all-solid-state lithium-ion rechargeable batteries have fewer restrictions of equipment size (the amount of power consumption), which results in wider application.

According to JP 2004-158222 A, there can be provided a multilayer laminated battery whose manufacturing process does not require a photoresist process and is significantly simplified (i.e., manufacturing cost reduction can be achieved). However, since the multilayer laminated battery of JP 2004-158222 A is a technology related to thin-film type all-solid-state lithium-ion rechargeable batteries, it would be difficult to simply apply the technology to large-capacity rechargeable batteries for large-sized electric equipment.

According to WO 2012/020700 A1, there can be provided a laminated solid-state battery that can be fabricated by integral sintering while suppressing the generation of interlaminar exfoliation and cracks. This is made possible because in the positive electrode layers, the negative electrode layers, the solid electrode layers, and the internal current collector layers that configure the laminated solid-state battery, a lithium-containing phosphoric acid compound can be contained in the active materials and the solid electrolyte material contained in the positive electrode layers and/or the negative electrode layers, the solid electrolyte material contained in the solid electrolyte layers, and the specific conductive material contained in the internal current collector layers, so that the layers have a phosphoric acid skeleton in common. However, it is considered that the laminated solid-state battery described in WO 2012/020700 A1 is assumed to be a relatively small rechargeable battery for use in small-sized electronic devices. Therefore, it would be difficult to simply apply the technology to large-capacity rechargeable batteries for large-sized electric equipment.

According to WO 2012/164642 A1, there can be provided a bipolar all-solid-state battery capable of preventing breakage of each current collector in the vicinity of the end of the bipolar all-solid-state battery to suitably prevent short-circuits from occurring by disposing a reinforcing layer between the end of each electrode active material layer and the surface of the adjacent current collector. It also discloses that the material for each current collector is preferably thin metal foil, and the material for the reinforcing layer is preferably a resin material. However, in the case where a resin material is used for the reinforcing layer, performing integral high-temperature firing in the manufacturing process of the bipolar all-solid-state battery is considered to be difficult from the viewpoint of heat resistance of the resin material.

In an all-solid-state lithium-ion rechargeable battery, the solid electrolyte, as a lithium-ion conducting path, has no fluidity. For a high battery output, therefore, not only the solid electrolyte itself needs to have a high ionic conductivity, but also a good ion conducting path needs to be established between a solid electrolyte layer and an electrode active material layer (obstacles to ion conduction need to be reduced as much as possible), and a good electron conducting path needs to be established between an electrode active material layer and a bipolar electrode. In addition, in the case of a bipolar laminated battery, internal short-circuits need to be prevented.

In order to meet these requirements, it is preferred that integral high-temperature firing be performed on an entire bipolar laminated body while preventing internal short-circuits. However, this is difficult to achieve simply by combining the above-mentioned prior technologies, and further ingenuity is required.

### SUMMARY OF THE INVENTION

In view of the foregoing, it is an objective of the present invention to provide a bulk-type bipolar laminated all-solid-state lithium-ion rechargeable battery that has a structure to prevent internal short-circuits and is capable of being fabricated by performing integral high-temperature firing on an entire bipolar laminated body, and a method for manufacturing the all-solid-state lithium-ion rechargeable battery.

(I) According to one aspect of the present invention, there is provided a bipolar laminated all-solid-state lithium-ion rechargeable battery including a plurality of bipolar electrodes and a plurality of solid electrolyte layers that are alternately laminated. Each bipolar electrode is made up of a current collector layer, a positive electrode layer formed on one principal surface of the current collector layer, and a negative electrode layer formed on the other principal surface of the current collector layer. When viewed from the lamination direction, each bipolar electrode and each solid electrolyte layer has a quadrilateral or circular shape, and the current collector layer of each bipolar electrode has its outer edge inside the outer edge of the positive electrode layer and the negative electrode layer of the bipolar electrode. At least one of the positive electrode layer and the negative electrode layer of each bipolar electrode is provided with at least one electrical insulating portion in a quadrilateral or circular outer edge region on the surface where it is in contact with the current collector layer of the bipolar electrode. When each bipolar electrode is viewed from the lamination direction, the projection (perspective projection) of the at least one electrical insulating portion configures the entire periphery of the outer edge of the quadrilateral or circular shape. The plurality of bipolar electrodes and the plurality of solid electrolyte layers form a sinter-bonded body. Meanwhile, it is noted that in the present invention, quadrilateral shapes include rectangles with rounded corners, and circular shapes include perfect circles, ellipses, ovals, and rounded rectangles (so-called, racetrack shapes).

In the above bipolar laminated all-solid-state lithium-ion rechargeable battery (I), the following modifications and changes can be made.

(i) When viewed from the lamination direction, each bipolar electrode and each solid electrolyte layer have a quadrilateral shape. Furthermore, the at least one electrical insulating portion of the positive electrode layer is disposed in one pair of opposite side regions of the quadrilateral shape, and the at least one electrical insulating portion of the negative electrode layer is disposed in the other pair of opposite side regions of the quadrilateral shape.

(ii) The current collector layer contains a main component consisting of at least one of a carbon-based material and an electrical conductive oxide. The positive electrode layer contains a main component consisting of a lithium transition metal composite oxide. The negative electrode layer contains a main component consisting of at least one of a carbon-based material, a lithium transition metal composite oxide, and a lithium transition metal composite nitride. Each solid electrolyte layer contains a main component consisting of a lithium composite oxide electrolyte. Meanwhile, it is noted that in the present invention, “main component” means “component to be used as the skeleton or aggregate of each relevant layer.

(II) According to another aspect of the present invention, there is provided a method for manufacturing a bipolar laminated all-solid-state lithium-ion rechargeable battery including a current collector layer green substrate preparation step, a positive electrode layer green substrate preparation step, a negative electrode layer green substrate preparation step, a solid electrolyte layer green substrate preparation step, an all-solid-state battery green substrate laminated body formation step, and an all-solid-state battery green substrate laminated body firing step. The bipolar laminated all-solid-state lithium-ion rechargeable battery includes a plurality of bipolar electrodes and a plurality of solid electrolyte layers that are alternately laminated. Each bipolar electrode is made up of a current collector layer, a positive electrode layer formed on one principal surface of the current collector layer, and a negative electrode layer formed on the other principal surface of the current collector layer. A plurality of current collector layer green substrates are prepared by forming a current collector layer green sheet containing a main component of the current collector layer and a resin binder and by cutting the current collector layer green sheet into a quadrilateral or circular shape of predetermined dimensions. A plurality of positive electrode layer green substrates are prepared by forming a positive electrode layer green sheet containing a main component of the positive electrode layer and a resin binder and by cutting the positive electrode layer green sheet into a quadrilateral or circular shape of predetermined dimensions. A plurality of negative electrode layer green substrates are prepared by forming a negative electrode layer green sheet containing a main component of the negative electrode layer and a resin binder and by cutting the negative electrode layer green sheet into a quadrilateral or circular shape of predetermined dimensions. A plurality of solid electrode layer green substrates are prepared by forming a solid electrolyte layer green sheet containing a main component of the plurality of solid electrolyte layers and a resin binder and by cutting the solid electrolyte layer green sheet into a quadrilateral or circular shape of predetermined dimensions. An all-solid-state battery green substrate laminated body is formed by sequentially laminating the negative electrode layer green substrates, the current collector layer green substrates, the positive electrode layer green substrates, and the solid electrolyte layer green substrates as prepared above. The all-solid-state battery green substrate laminated body is subjected to a firing process as a whole to form an all-solid-state battery sinter-bonded body in which the negative electrode layer, the current collector layer, and the positive electrode layer of each bipolar electrode, and the solid electrolyte layers are sinter-bonded. When viewed from the lamination direction, each bipolar electrode and each solid electrolyte layer is formed to have a quadrilateral or circular shape, and the current collector layer of each bipolar electrode is configured to have its outer edge inside the outer edge of the positive electrode layer and the negative electrode layer of the bipolar electrode. At least one of the positive electrode layer and the negative electrode layer of each bipolar electrode is provided with at least one electrical insulating portion in a quadrilateral or circular outer edge region on the surface where it is in contact with the current collector layer of the bipolar electrode. When each bipolar electrode is viewed from the lamination direction, the projection (perspective projection) of the at least one electrical insulating portion of the bipolar electrode is made up of the entire periphery of the outer edge of the quadrilateral or circular shape. At least one of the positive electrode layer green substrate preparation step and the negative electrode layer green substrate preparation step is a step of forming an electrical insulating portion green sheet to become the at least one electrical insulating portion, then laminating at least one of a positive electrode active material portion green sheet and a negative electrode active material portion green sheet so as to integrally embed the electrical insulating portion green sheet therein to form at least one of the positive electrode layer green sheet and the negative electrode layer green sheet, and subsequently performing a cut-out process such that the at least one electrical insulating portion to be cut out from the electrical insulating portion green sheet is disposed in the quadrilateral or circular outer edge region. The all-solid-state battery green substrate laminated body formation step includes a step of forming a plurality of bipolar electrode green substrates by laminating each positive electrode layer green substrate on one principal surface of each current collector layer green substrate and laminating each negative electrode layer green substrate on the other principal surface of the current collector layer green substrate. The bipolar electrode green substrate formation step is a step of laminating each positive electrode layer green substrate and each negative electrode layer green substrate on each current collector layer green substrate such that the at least one electrical insulating portion of at least one of the positive electrode layer green substrate and the negative electrode layer green substrate faces the current collector layer green substrate, and when each bipolar electrode green substrate is viewed from the lamination direction, the projection of the at least one electrical insulating portion of the bipolar electrode is made up of the entire periphery of the outer edge of the quadrilateral or circular shape.

In the above method for manufacturing a bipolar laminated all-solid-state lithium-ion rechargeable battery (II), the following modifications and changes can be made.

(iii) When viewed from the lamination direction, each bipolar electrode and each solid electrolyte layer has a quadrilateral shape. Furthermore, the bipolar electrode green substrate formation step is a step of laminating each of the plurality of the positive electrode layer green substrates and each of the plurality of the negative electrode layer green substrates on each of the plurality of current collector layer green substrates such that when viewed from the lamination direction, the at least one electrical insulating portion of the positive electrode layer green substrate is disposed in one pair of opposite side regions of the quadrilateral shape, and the at least one electrical insulating portion of the negative electrode layer green substrate is disposed in the other pair of opposite side regions of the quadrilateral shape.

(iv) The current collector layer green substrate preparation step is a step of adjusting a current collector layer slurry to form the current collector layer green sheet such that a shrinkage amount of the plurality of current collector layer green substrates is greater than those of the plurality of positive electrode layer green substrates and the plurality of negative electrode layer green substrates during the all-solid-state battery green substrate laminated body firing step.

(v) The all-solid-state battery green substrate laminated body formation step further comprises a positive monopolar electrode green substrate formation step, a negative monopolar electrode green substrate formation step, and a laminated body assembly step. The positive monopolar electrode green substrate formation step is a step of laminating a positive electrode layer green substrate on one principal surface of a current collector layer green substrate to form a positive monopolar electrode green substrate. The negative monopolar electrode green substrate formation step is a step of laminating a negative electrode layer green substrate on one principal surface of a current collector layer green substrate to form a negative monopolar electrode green substrate. The laminated body assembly step includes steps of alternately laminating the plurality of bipolar electrode green substrates and the plurality of solid electrolyte layer green substrates to form a bipolar electrode green substrate-solid electrolyte layer green substrate laminated body, laminating the positive monopolar electrode green substrate on one end of the bipolar electrode green substrate-solid electrolyte layer green substrate laminated body in the lamination direction, and laminating the negative monopolar electrode green substrate on the other end of the bipolar electrode green substrate-solid electrolyte layer green substrate laminated body in the lamination direction.

(vi) The current collector layer contains a main component consisting of at least one of a carbon-based material and an electrical conductive oxide. The positive electrode layer contains a main component consisting of a lithium transition metal composite oxide. The negative electrode layer contains a main component consisting of at least one of a carbon-based material, a lithium transition metal composite oxide, and a lithium transition metal composite nitride. Each solid electrolyte layer contains a main component consisting of a lithium composite oxide electrolyte.

### Advantages of the Invention

According to embodiments of the present invention, there can be provided a bulk-type bipolar laminated all-solid-state lithium-ion rechargeable battery which has a structure to prevent internal short-circuits and is capable of being fabricated by performing integral high-temperature firing on an entire bipolar laminated body. Also, there can be provided a method for manufacturing the all-solid-state lithium-ion rechargeable battery.

### BRIEF DESCRIPTION OF THE DRAWINGS

FIG. 1 is a process chart illustrating a method for manufacturing a bipolar laminated all-solid-state lithium-ion rechargeable battery according to embodiments of the present invention;

FIG. 2 is an exploded schematic view of an all-solid-state battery green substrate laminated body obtained in an all-solid-state battery green substrate laminated body formation step according to a first embodiment of the invention;

FIG. 3 is a longitudinal sectional schematic view of an all-solid-state battery sinter-bonded body obtained by an all-solid-state battery green substrate laminated body firing step according to the first embodiment of the invention;

FIG. 4A is a schematic perspective diagram illustrating processes of a positive electrode layer green substrate preparation step according to the first embodiment of the invention;

FIG. 4B is a schematic diagram illustrating processes of the positive electrode layer green substrate preparation step according to a second embodiment of the invention;

FIG. 4C is a schematic diagram illustrating processes of the positive electrode layer green substrate preparation step according to a third embodiment of the invention;

FIG. 5 is a longitudinal sectional schematic view of an all-solid-state battery structure obtained by an external terminal connection step according to the first embodiment of the invention; and

FIG. 6 is a longitudinal sectional schematic view of an all-solid-state battery obtained by a packaging step according to the first embodiment of the invention.

### DETAILED DESCRIPTION OF THE PREFERRED EMBODIMENTS

### Basic Concepts of the Present Invention

As mentioned before, in an all-solid-state lithium-ion rechargeable battery, the solid electrolyte, as a lithium-ion conducting path, has no fluidity. For a high battery output, therefore, not only the solid electrolyte itself needs to have a high ionic conductivity, but also a good ion conducting path needs to be established between a solid electrolyte layer and an electrode active material layer (obstacles to ion conduction need to be reduced as much as possible), and a good electron conducting path needs to be established between an electrode active material layer and a bipolar electrode. In addition, in the case of a bipolar laminated battery, internal short-circuits need to be prevented. In order to meet these requirements, it is desirable to form a sinter-bonded body by integrally sintering an entire bipolar laminated body (an entire laminated body including positive electrode layers, current collector layers, negative electrode layers, and solid electrolyte layers).

WO 2012/020700 A1 teaches a technical idea of integrally sintering an entire bipolar laminated body. However, the difference in amount of firing shrinkage between the layers that configure the laminated body is not taken into consideration. This is conceivably because the battery of WO 2012/020700 A1 is assumed to be a relatively small rechargeable battery (e.g., a laminated body with a diameter of 12 mm) for use in small-sized electronic devices. More specifically, if a 5 percent difference occurred in amount of firing shrinkage between the layers, the difference in diameter would be 0.6 mm with respect to a diameter of 12 mm (i.e., a deviation of 0.3 mm on each side). It is considered that with such a small difference in absolute amount of shrinkage, the risk of internal short-circuits of the battery is negligible.

In contrast, the battery of the present invention is assumed to be a large-capacity rechargeable battery (e.g., a laminated body measuring 50 to 100 mm per side when viewed from the lamination direction) for use in large-sized electrical equipment. In this case, if a 5 percent difference occurred in amount of firing shrinkage between the layers in a laminated body measuring 60 mm per side, the difference in length per side would be as large as 3 mm (i.e., a deviation of 1.5 mm on each side). The problem is that since the larger the entire dimensions are, the larger the difference in absolute amount of shrinkage becomes, the risk of internal short-circuits in the battery increases sharply.

Therefore, the present inventor conducted intensive research on a laminated body structure capable of preventing internal short-circuits in a battery even when a certain degree of difference occurs in amount of firing shrinkage, and a method for manufacturing such a laminated body structure. As a result, the present inventor found that internal short-circuits in a battery (short-circuits between a positive electrode layer and a negative electrode layer and short-circuits between current collector layers) can be effectively prevented by controlling the amount of firing shrinkage of a current collector layer so as to be larger than those of a positive electrode layer and a negative electrode layer and by forming an electrical insulating portion in outer edge regions of the positive electrode layer and the negative electrode layer on the surfaces where the positive electrode layer and the negative electrode layer are in contact with the current collector layer. The present invention was made based on this finding.

Preferred embodiments of the present invention will be specifically described for each manufacturing step hereinafter with reference to the accompanying drawings. However, the invention is not limited to the specific embodiments described below, and various combinations with a well-known technique and modifications based on a well-known technique are possible without departing from the technical idea of the invention where appropriate. In the drawings, like reference numerals or characters represent like members and portions, and duplicated descriptions will be omitted to avoid repetition.

Although the descriptions in the present specification are given with a lithium-ion rechargeable battery as an exemplary all-solid-state rechargeable battery, the technical idea of the present invention can be applied to sodium ion rechargeable batteries, magnesium ion rechargeable batteries, aluminum ion rechargeable batteries, etc. besides lithium-ion rechargeable batteries.

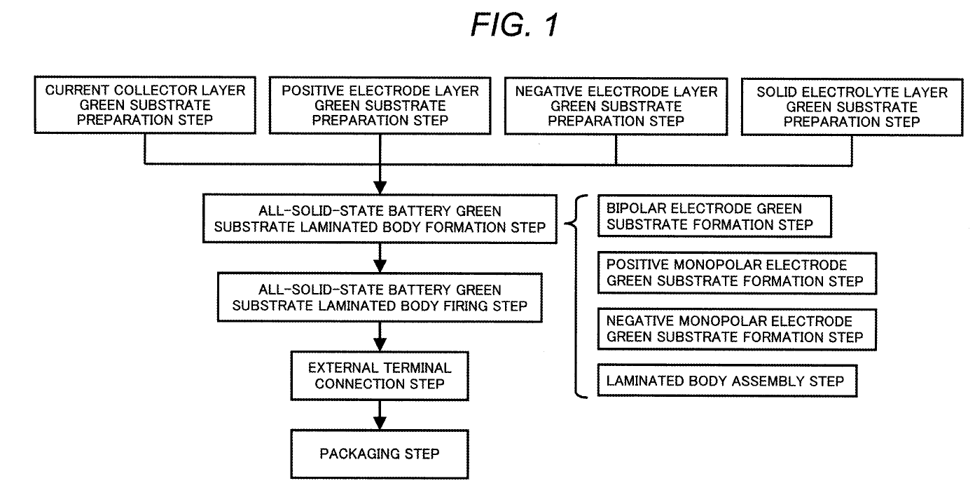

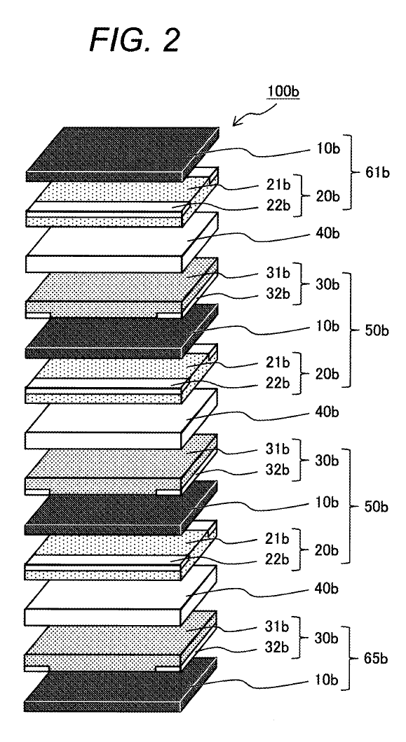

FIG. 1 is a process chart illustrating a method for manufacturing a bipolar laminated all-solid-state lithium-ion rechargeable battery according to embodiments of the present invention. FIG. 2 is an exploded schematic view of an all-solid-state battery green substrate laminated body obtained in an all-solid-state battery green substrate laminated body formation step according to a first embodiment of the invention.

As shown in FIGS. 1 and 2, the manufacturing method according to the first embodiment of the invention includes a current collector layer green substrate preparation step of preparing current collector layer green substrates 10b; a positive electrode layer green substrate preparation step of preparing positive electrode layer green substrates 20b; a negative electrode layer green substrate preparation step of preparing negative electrode layer green substrates 30b; a solid electrolyte layer green substrate preparation step of preparing solid electrolyte layer green substrates 40b; an all-solid-state battery green substrate laminated body formation step of forming an all-solid-state battery green substrate laminated body 100b from the current collector layer green substrates 10b, the positive electrode layer green substrates 20b, the negative electrode layer green substrates 30b, and the solid electrolyte layer green substrates 40b; and an all-solid-state battery green substrate laminated body firing step of sinter-bonding the all-solid-state battery green substrate laminated body 100b as a whole to form an all-solid-state battery sinter-bonded body. Meanwhile, in the present invention, the term “green” means a state before firing.

The all-solid-state battery green substrate laminated body formation step may be made up of: a bipolar electrode green substrate formation step of forming bipolar electrode green substrates 50b from current collector layer green substrates 10b, positive electrode layer green substrates 20b, and negative electrode layer green substrates 30b; a positive monopolar electrode green substrate formation step of forming a positive monopolar electrode green substrate 61b from a current collector layer green substrate 10b and a positive electrode layer green substrate 20b; a negative monopolar electrode green substrate formation step of forming a negative monopolar electrode green substrate 65b from a current collector layer green substrate 10b and a negative electrode layer green substrate 30b; and a laminated body assembly step of forming an all-solid-state battery green substrate laminated body 100b from the positive monopolar electrode green substrate 61b, the solid-electrolyte layer green substrates 40b, the bipolar electrode green substrates 50b and the negative monopolar electrode green substrate 65b.

Where necessary, the manufacturing method according to the first embodiment of the invention may further include: an external terminal connection step of connecting an external terminal to the positive monopolar electrode and the negative monopolar electrode; and a packaging step of packaging an all-solid-state battery structure.

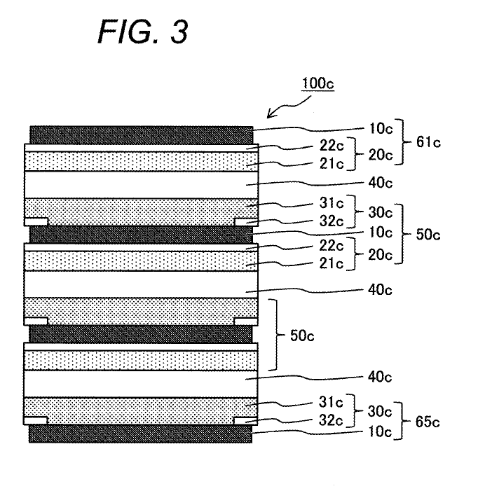

By the all-solid-state battery green substrate laminated body firing step, each of the laminated green substrates shrinks by firing while the sinter-bonding progresses between the layers, which enables the formation of an all-solid-state battery sinter-bonded body. FIG. 3 is a longitudinal sectional schematic view of an all-solid-state battery sinter-bonded body obtained by the all-solid-state battery green substrate laminated body firing step according to the first embodiment of the present invention.

As shown in FIG. 3, an all-solid-state battery sinter-bonded body 100c includes a positive monopolar electrode 61c (configuring a current collector layer 10c and a positive electrode layer 20c), solid electrolyte layers 40c, bipolar electrodes 50c (each configuring a negative electrode layer 30c, a current collector layer 10c, and a positive electrode layer 20c), and a negative monopolar electrode 65c (configuring a negative electrode layer 30c and a current collector layer 10c). Because the formation of the current collector layer green substrates 10b is controlled in the firing step such that the amount of firing shrinkage of them is larger than those of other green substrates (the positive electrode layer green substrates 20b and the negative electrode layer green substrates 30b), each current collector layer 10c is formed with its outer edge inside the outer edge of the adjacent positive electrode layer 20c and the adjacent negative electrode layer 30c.

Furthermore, in the example shown in FIG. 3, an electrical insulating portion 22c is formed in each of a pair of opposite side regions (a pair of opposite side regions of a quadrilateral shape when viewed from the lamination direction) of each positive electrode layer 20c, and an electrical insulating portion 32c is formed in each of a pair of opposite side regions (the other pair of opposite side regions of the quadrilateral shape when viewed from the lamination direction) of each negative electrode layer 30c. In other words, when each bipolar electrode 50c is viewed from the lamination direction, the projection (perspective projection) of the electrical insulating portions 22c and 32c configure the entire periphery of the outer edge of the quadrilateral shape. This configuration makes it possible to prevent internal short-circuits from occurring even if the positive electrode layer 20c is in contact with the negative electrode layer 30c in each bipolar electrode 50c.

Each step of the method for manufacturing a bipolar laminated all-solid-state lithium-ion rechargeable battery according to embodiments of the present invention will be described hereinafter in a more specific manner.

(Positive Electrode Layer Green Substrate Preparation Step)

This step is a step of forming a positive electrode layer green sheet and subsequently cutting it into a quadrilateral or circular shape of predetermined dimensions to prepare the positive electrode layer green substrates 20b. Each positive electrode layer green substrate 20b configures a positive electrode active material portion 21b and electrical insulating portions 22b. In the example of FIG. 2, the electrical insulating portions 22b are formed in a pair of opposite side regions of a quadrilateral shape.

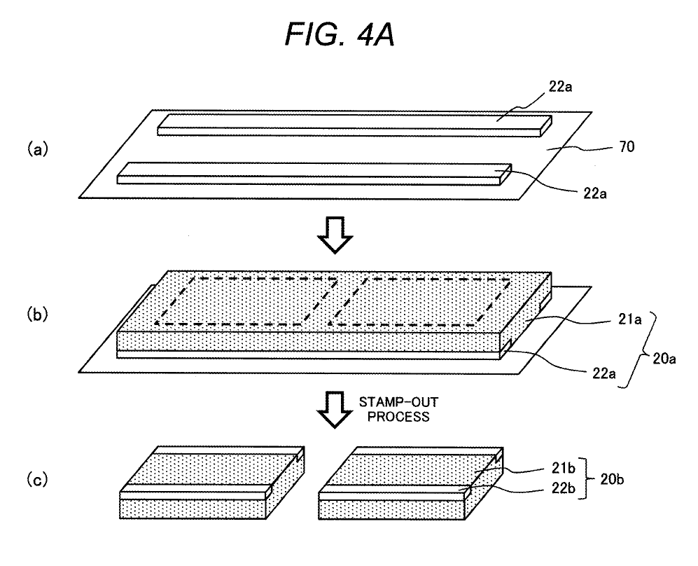

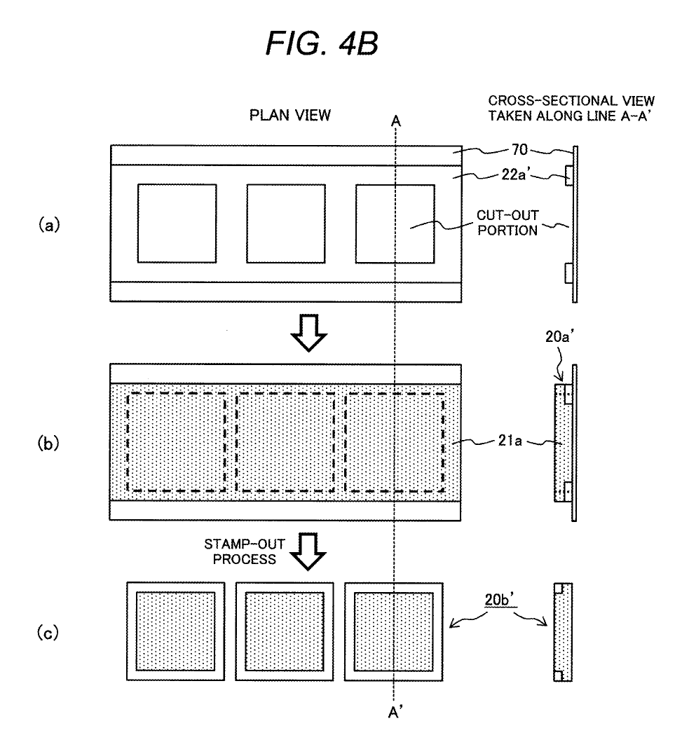

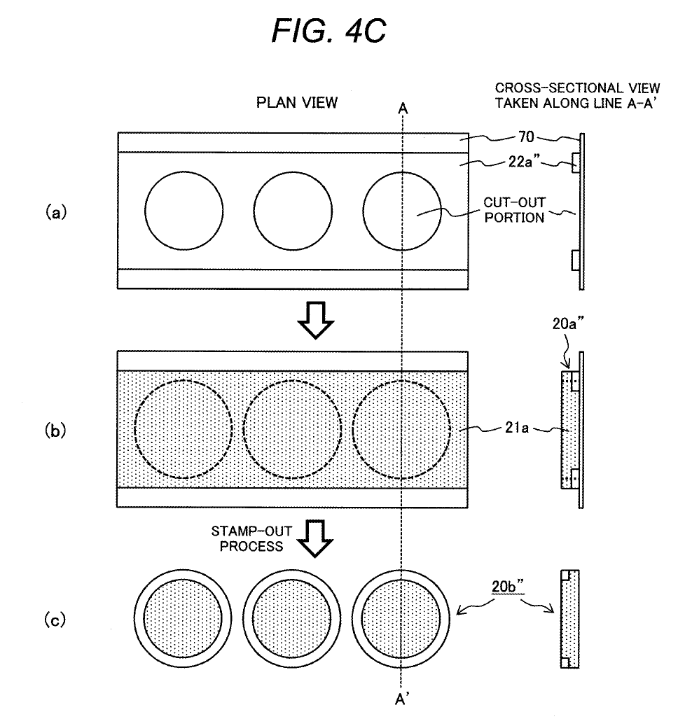

FIG. 4A is a schematic perspective diagram illustrating processes of the positive electrode layer green substrate preparation step according to the first embodiment of the invention. As shown in FIG. 4A, first, a parallel pair of electrical insulating portion green sheets 22a is formed on a carrier sheet 70. Next, a positive electrode active material portion green sheet 21a is laminated so as to integrally embed the parallel pair of electrical insulating portion green sheets 22a to form a positive electrode layer green sheet 20a. Subsequently, a cut-out process is performed such that the parallel pair of electrical insulating portion green sheets 22a is disposed in a pair of opposite side regions of a quadrilateral shape to prepare the positive electrode layer green substrates 20b.

There are no particular limitations on the formation method of each green sheet, and the doctor blading method and the screen printing method may be suitably employed, for example. Also, there are no particular limitations on the cut-out process of green substrates, and a stamp-out process may be suitably employed. The same applies to the green sheet formation methods described below.

FIG. 4B is a schematic diagram illustrating the processes of the positive electrode layer green substrate preparation step according to a second embodiment of the invention. As shown in FIG. 4B, first, an electrical insulating portion green sheet 22a′ having quadrilateral cut-out portions are formed on a carrier sheet 70. Next, a positive electrode active material portion green sheet 21a is laminated so as to integrally embed the electrical insulating portion green sheet 22a′ to form a positive electrode layer green sheet 20a′. Subsequently, a cut-out process is performed such that the electrical insulating portion sheet 22a′ is disposed on the entire periphery of an outer edge region of a quadrilateral shape to prepare positive electrode layer green substrates 20b′.

FIG. 4C is a schematic diagram illustrating the processes of the positive electrode layer green substrate preparation step according to a third embodiment of the present invention. As shown in FIG. 4C, first, an electrical insulating portion green sheet 22a″ having circular cut-out portions are formed on a carrier sheet 70. Next, a positive electrode active material portion green sheet 21a is laminated so as to integrally embed the electrical insulating portion sheet 22a″ to form a positive electrode layer green sheet 20a″. Subsequently, a cut-out process is performed such that the electrical insulating portion sheet 22a″ is disposed on the entire periphery of an outer edge region of a circular shape to prepare positive electrode layer green substrates 20b″.

The width of each of the electrical insulating portion green sheets 22a, 22a′, 22a″ disposed in each of the positive electrode layer green substrates 20b, 20b′, 20b″ is set appropriately by calculating backward from the amount of firing shrinkage of each green substrate in the firing step that follows so as to prevent short-circuits between the positive electrode layer and the negative electrode layer that sandwiches each current collector.

The positive electrode active material portion green sheet 21a contains at least a positive electrode active material as a main component and a resin binder as a shape maintenance component. The green sheet 21a preferably further contains a sintering additive from the view point of improving the sinterbility among positive electrode active material particles in the firing step. Also, it preferably further contains a conductive additive from the view point of improving the electrical conductivity of the positive electrode active material portion.

The positive electrode active material is a crystal material that releases lithium-ions during charging and stores lithium-ions during discharging, and any positive electrode active material for use in prior and existing lithium-ion rechargeable batteries can be employed. Preferred examples include lithium transition metal composite oxides such as LiCoO₂, LiNiO₂, LiMn₂O₄, LiMnO₃, LiMn₂O₃, LiMnO₂, Li₄Mn₅O₁₂, Li₂Mn₃MO₈ (M=Fe, Co, Ni, Cu, Zn), Li₁₋ₓMₓMn₂O₄ (M=Mg, B, Al, Fe, Co, Ni, Cr, Zn, Ca, x=0.01 to 0.1), LiMn₂₋ₓMₓO₂ (M=Co, Ni, Fe, Cr, Zn, Ta, x=0.01 to 0.2), LiCo₁₋ₓMₓO₂ (M=Ni, Fe, Mn, x=0.01 to 0.2), LiNi₁₋ₓMₓO₂ (M=Mn, Fe, Co, Al, Ga, Ca, Mg, x=0.01 to 0.2), LiNi_{1-x-y}MnₓCo_{y}O₂ (x=0.1 to 0.8, y=0.1 to 0.8, x+y=0.1 to 0.9), LiFeO₂, LiFePO₄, and LiMnPO₄.

The sintering additive is a material to assist the sinter-bonding within each positive electrode layer, between each positive electrode layer and the adjacent current collector layer, and between each positive electrode layer and the adjacent solid electrolyte layer. It preferably has an excellent bondability and a good ionic conductivity. Preferred examples include B₂O₃, Li₃PO₄, Li₃BO₃, glass materials based on one of these, and solid electrolyte materials.

The conductive additive is a material to assist the electrical conduction within each positive electrode layer and between each positive electrode layer and the adjacent current electrode layer. It preferably has better electron conductivity than that of the positive electrode active material. Preferred examples include electrical conductive fibers (e.g., vapor-grown carbon, carbon nano-tubes, fibers fabricated by carbonizing pitch at high temperature, and carbon fibers fabricated from acrylic fibers). Electrical conductive materials that do not oxidize at the charge/discharge potential of the battery (normally ranging from 2.5 to 4.5 V) such as corrosion resistant metals (e.g., titanium and gold), oxides (e.g., indium tin oxide, SnO, and ZnO), carbides (e.g., SiC and WC), nitrides (e.g., Si₃N₄ and BN), and carbon materials with a high specific surface area (e.g., carbon black and activated carbon) may also be employed.

The resin binder is a material to maintain the shape of the green sheet 21a. There are no particular limitations on the material as long as it does not inhibit the sinter-bonding of the layers in the firing step. Preferred examples include polyvinyl butyral (PVB) and ethyl cellulose (EC). Where necessary, the binder may further contain a plasticizer (e.g., dioctyl phthalate, DOP).

The pair of electrical insulating portion green sheets 22a contains at least an electrical insulating material as a main component and a resin binder as a shape maintenance component. The green sheets 22a also preferably contain a sintering additive from the viewpoint of improving the sinterbility among electrical insulating material particles in the firing step.

It is noted that the descriptions concerning the electrical insulating portion sheets 22a also apply to the electrical insulating portion green sheet 22a′ and the electrical insulating portion green sheet 22a″.

There are no particular limitations on the electrical insulating material as long as it provides electrical insulation (with a resistivity of 10¹² Ωcm or greater) at the charge/discharge potential of the battery (normally ranging from 2.5 to 4.5 V) and is an oxide material that does not burn out or flow out in the firing step (at 800° C., for example). Preferred examples include silica glass.

The sintering additive for the green sheets 22a is, similarly to the electrical insulating material, preferably a material that provides electrical insulation at the charge/discharge potential of the battery and does not burn out or flow out in the firing step. In addition, it preferably has an excellent bondability. Preferred examples include silica gel.

Preferred examples of the resin binder for the green sheets 22a include, as is the case with the green sheet 21a, PVB and EC. Where necessary, the binder may further contain a plasticizer (e.g., DOP).

Each positive electrode layer green substrate 20b is a composite of the positive electrode active material portion 21b and the electrical insulating portions 22b. Since each of them contains a resin component (i.e., a resin binder and a plasticizer), each positive electrode layer green substrate 20b normally shrinks in the firing step by an amount corresponding to the content of the resin component. In order to prevent cracks and interlaminar exfoliation from occurring in the sintered body due to the shrinkage by firing, it is necessary to control the shrinkage of the positive electrode active material portion 21b and the electrical insulating portions 22b such that the difference between the amount of firing shrinkage of the positive electrode active material portion 21b and that of the electrical insulating portions 22b is not large.

It is noted that the descriptions concerning the positive electrode layer green substrates 20b also apply to the positive electrode layer green substrates 20b′ and the positive electrode layer green substrates 20b″.

Specifically, at the stage of the formation of each green sheet (more specifically, the stage at which a slurry or paste is prepared to form each green sheet), the content (strictly, it is the volume content; but in terms of manufacturing process, it is the mass content considering specific gravities) of the inorganic material component in the sum of the inorganic material component and the resin component in the slurry or paste is controlled. For simplification, “slurry or paste” will be hereinafter collectively referred to as “slurry”.

By controlling the difference between the content of the inorganic material component in the slurry for the positive electrode active material portion green sheet 21a and that in the slurry for the electrical insulating portion green sheets 22a such that it is within 5 percent, the generation of cracks and interlaminar exfoliation in the sintered body can be effectively suppressed. In this case, the content of the inorganic material component in the slurry for the positive electrode active material portion green sheet 21a is preferably equal to or lower than that in the slurry for the electrical insulating portion green sheets 22a.

Also, among the inorganic material component in the slurry (when the total amount of the inorganic material component is 100 percent), the content of the main component is preferably 60 percent or higher. The content of the main component of 60 percent or higher allows the main component to configure the aggregate (skeleton) of the sintered body, which enables the control of the effective linear expansion coefficient of the sintered body. As a result, the generation of interlaminar exfoliation and cracks caused by thermal history or heat cycles can be effectively suppressed. The same applies to the slurries for the other layers. Incidentally, the balance of the inorganic material component in the slurry (the content: 40 percent or lower) is made up of a sintering additive and/or a conductive additive.

(Negative Electrode Layer Green Substrate Preparation Step)

This step is a step of forming a negative electrode layer green sheet and subsequently cutting it into a quadrilateral or circular shape of predetermined dimensions to prepare the negative electrode layer green substrates 30b. Each negative electrode layer green substrate 30b is made up of a negative electrode active material portion 31b and electrical insulating portions 32b. In the example of FIG. 2, the electrical insulating portions 32b are formed in a pair of opposite side regions of a quadrilateral shape.

The negative electrode layer green substrates 30b can be prepared by the same step as the positive electrode layer green substrates 20b (see FIG. 4A) except that the composition of the negative electrode active material portion 31b is different from that of the positive electrode active material portion 21b.

Meanwhile, it is noted that as to the negative electrode layer green substrates that correspond to the positive electrode layer green substrates 20b′ or 20b″, negative electrode layer green substrates where an electrical insulating portion is provided by the same step as the positive electrode layer green substrates 20b′ or 20b″ (see FIG. 4B or FIG. 4C) may be prepared; however, negative electrode layer green substrates where no electrical insulating portion is provided may be prepared. This is because the electrical insulating portion provided on the entire periphery of the outer edge of each positive electrode layer green substrate 20b′ or 20b″ prevents internal short-circuits of each bipolar electrode.

From this point of view, when preparing negative electrode layer green substrates where the same step as shown in FIG. 4B or 4C is used to provide an electrical insulating portion on the entire periphery of the outer edge of the substrate, positive electrode layer green substrates where no electrical insulating portion is provided may be prepared as the corresponding positive electrode layer green substrates.

However, even in the negative electrode layer green substrates corresponding to the positive electrode layer green substrates 20b′ or 20b″, as for the negative electrode active material portion 31b, it is the same as that of the negative electrode layer green substrates 30b.

The negative electrode active material portion green sheet contains at least a negative electrode active material as a main component and a resin binder as a shape maintenance component. The green sheet preferably further contains a sintering additive from the view point of improving the sinterbility among negative electrode active material particles in the firing step. Also, it preferably further contains a conductive additive from the view point of improving the electrical conductivity of the negative electrode active material portion.

The negative electrode active material is a crystal material that stores lithium-ions during charging and releases lithium-ions during discharging, and any negative electrode active material for use in prior and existing lithium-ion rechargeable batteries can be employed. Preferred examples include carbon-based materials (e.g., carbon black, easily graphitizable carbon materials, and amorphous carbon materials), lithium transition metal composite oxides (e.g., Li₄Ti₅O₁₂ and LiTiO₄), and lithium transition metal composite nitrides (e.g., LiCoN). It is noted that carbon-based materials function also as a conductive additive.

Preferred examples of the sintering additive for the negative electrode active material portion green sheet include those for the positive electrode active material portion green sheet 21a (e.g., B₂O₃, Li₃PO₄, Li₃BO₃, glass materials based on one of these, and solid electrolyte materials).

Preferred examples of the conductive additive for the negative electrode active material portion green sheet include metal lithium powder and powders of metals that can be alloyed with lithium (e.g., aluminum, silicon, and tin). Since these metals also function as a negative electrode active material, it is preferred that one of them be contained in the negative electrode active material portion green sheet. In order to suppress the generation of cracks and interlaminar exfoliation in the sintered body, it is preferably contained as a conductive additive, not as a main component of the negative electrode active material portion green sheet because the linear expansion coefficient of a metal is larger than that of an oxide by approximately one order of magnitude (in other words, the amount of heat expansion/shrinkage of a metal is approximately ten times larger than that of an oxide).

The relationship between the content of the inorganic material component in the slurry for the negative electrode active material portion green sheet and that in the slurry for the electrical insulating portion green sheet is the same as that in the positive electrode layer green sheet 20a.

(Current Collector Layer Green Substrate Preparation Step)

This step is a step of forming a current collector layer green sheet and subsequently cutting it into a quadrilateral or circular shape of predetermined dimensions to prepare the current collector layer green substrates 10b. There are no particular limitations on the formation method of the green sheet, and the doctor blading method and the screen printing method may be suitably employed, for example. Also, there are no particular limitations on the cut-out process of green substrates, and a stamp-out process may be suitably employed.

The current collector layer green sheet contains at least a conductive (electron conductive) material as a main component and a resin binder as a shape maintenance component. The green sheet preferably further contains a sintering additive from the view point of improving the sinterbility among conductive material particles in the firing step. Also, it preferably further contains a conductive additive from the view point of improving the electrical conductivity of each current collector layer.

Preferred examples of the main component of each current collector layer include carbon-based materials (e.g., glassy carbon) and electrical conductive oxides (e.g., indium tin oxide, SnO, and ZnO).

There are no particular limitations on the sintering additive for the current collector layer green sheet as long as it has an excellent sinterbility and does not inhibit the electrical conduction of the main component. Preferred examples include electrical conductive glass that is made up primarily of vanadium oxide.

Preferred examples of the conductive additive for the current collector layer green sheet include powders of highly conductive corrosion-resistant metals (e.g., gold, silver, copper, platinum, and nickel). As with the description above, to suppress the generation of cracks and interlaminar exfoliation in the sintered body, these metal powders are preferably contained as a conductive additive, not as a main component of the current collector layer green sheet.

As mentioned before, in the present invention, it is preferred that the amount of firing shrinkage of each current collector layer be controlled so as to be larger than those of each positive electrode layer and each negative electrode layer. For that purpose, the content of the inorganic material component in the sum of the inorganic material component and the resin component (i.e., the resin binder and the plasticizer) in the slurry that forms the current collector layer green sheet is preferably controlled such that it is equal to or lower than that in the slurry for the electrode active material portion green sheet of the positive electrode layers or the negative electrode layers and such that the difference between the two is within 5 percent. By doing so, the generation of cracks and interlaminar exfoliation in the sintered body can be effectively suppressed and internal short-circuits can be effectively prevented.

(Solid Electrolyte Layer Green Substrate Preparation Step)

This step is a step of forming a solid electrolyte layer green sheet and subsequently cutting it into a quadrilateral or circular shape of predetermined dimensions to prepare the solid electrolyte layer green substrates 40b. There are no particular limitations on the formation method of the green sheet, and the doctor blading method and the screen printing method may be suitably employed, for example. Also, there are no particular limitations on the cut-out process of green substrates, and a stamp-out process may be suitably employed.

The solid electrolyte layer green sheet contains at least a solid electrolyte as a main component and a resin binder as a shape maintenance component. The green sheet preferably further contains a sintering additive from the view point of improving the sinterbility among solid electrolyte particles in the firing step.

As the solid electrolyte, any solid electrolyte for use in prior and existing all-solid-state lithium rechargeable batteries can be employed as long as it has a high ionic conductivity and a heat resistance suitable for the firing step. Preferred examples include lithium composite oxides, and more specifically, garnet-type lithium composite oxides (e.g., Li₇La₃Zr₂O₁₂, Li₇₊ₓLa₃Zr₂O₁₂₋ₓMₓ (0<x<1.2, M is one of N, Cl, S, and Se), Li₅La₃Ta₂O₁₂, Li₅La₃Nb₂O₁₂, and Li₆BaLa₂Ta₂O₁₂), perovskite-type lithium composite oxides (e.g., Li_{0.34}La_{0.51}TiO_{2.94}), NASICON-type lithium composite oxides (e.g., Li_{1.1}Al_{0.7}Ti_{1.5}(PO₄)₃), glass-type lithium composite oxides (e.g., 50Li₄SiO₄-50Li₃BO₃, Li_{1.07}Al_{0.69}Ti_{1.46} (PO₄)₃, Li_{1.5}Al_{0.5}Ge_{1.5} (PO₄)₃, Li_{1.4}Al_{0.4}Ti_{1.6} (PO₄)₃, LiAlGe(PO₄)₃, Li₃BO₃, LiVO₃, Li_{3.4}V_{0.6}Si_{0.4}O₄, and Li₂P₂O₆). These solid electrolytes may be used singularly or in a form of mixture of two or more.

As the sintering additive for the solid electrolyte layer green sheet, the same material as that for the positive electrode active material portion green sheet 21a (e.g., B₂O₃, Li₃PO₄, Li₃BO₃, and glass materials based on one of these) can be suitably employed.

The difference between the content of the inorganic material component in the sum of the inorganic material component and the resin component in the slurry that forms the solid electrolyte layer green sheet and that in the slurry for the electrode active material portion green sheet of the positive electrode layers or the negative electrode layers is preferably controlled to be within 5 percent. By doing so, the generation of cracks and interlaminar exfoliation in the sintered body can be effectively suppressed and internal short-circuits can be effectively prevented.

The following descriptions will be given with the first embodiment, which is shown in FIGS. 2 and 3, being the representative embodiment for simplification.

(All-Solid-State Battery Green Substrate Laminated Body Formation Step)

This step is a step of forming the all-solid-state battery green substrate laminated body 100b from the current collector layer green substrates 10b, the positive electrode layer green substrates 20b, the negative electrode layer green substrates 30b, and the solid electrolyte layer green substrates 40b prepared in the steps described above. In forming the all-solid-state battery green substrate laminated body 100b as shown in FIG. 2, the layer green substrates may be sequentially laminated, or, as described below, the electrode green substrates (the bipolar electrode green substrates 50b, the positive monopolar electrode green substrate 61b, and the negative monopolar electrode green substrate 65b) may be formed in advance.

(a) Bipolar Electrode Green Substrate Formation Step

This step is a step of forming the bipolar electrode green substrates 50b from the current collector layer green substrates 10b, the positive electrode layer green substrates 20b, and the negative electrode layer green substrates 30b. As shown in FIG. 2, each current collector layer green substrate 10b, each positive electrode layer green substrate 20b, and each negative electrode layer green substrate 30b are laminated such that the electrical insulation portions 22b of the positive electrode layer green substrate 20b face one principal surface of the current collector layer green substrate 10b, and the electrical insulating portions 32b of the negative electrode layer green substrate 30b face the other principal surface of the current collector layer green substrate 10b. Furthermore, when viewed from the lamination direction, the electrical insulating portions 22b of the positive electrode layer green substrate 20b are disposed in one pair of opposite side regions of a quadrilateral shape, and the electrical insulating portions 32b of the negative electrode layer green substrate 30b are disposed in the other pair of opposite side regions of the quadrilateral shape.

(b) Positive Monopolar Electrode Green Substrate Formation Step

This step is a step of forming the positive monopolar electrode green substrate 61b from a current collector layer green substrate 10b and a positive electrode layer green substrate 20b. The positive electrode layer green substrate 20b is laminated on one principal surface of the current collector layer green substrate 10b. In FIG. 2, the positive electrode layer green substrate 20b in the positive monopolar electrode green substrate 61b has electrical insulating portions 22b. By using one of the positive electrode layer green substrates 20b as prepared in the positive electrode layer green substrate preparation step, the need for preparing another step is eliminated, which is an advantage in terms of process cost reduction as a whole. However, the present invention is not limited to this configuration, and the positive electrode layer green substrate in the positive monopolar electrode green substrate may not have any electrical insulating portions 22b.

(c) Negative Monopolar Electrode Green Substrate Formation Step

This step is a step of forming the negative monopolar electrode green substrate 65b from a current collector layer green substrate 10b and a negative electrode layer green substrate 30b. The negative electrode layer green substrate 30b is laminated on one principal surface of the current collector layer green substrate 10b. In the same way as the positive monopolar electrode green substrate 61b, the negative electrode layer green substrate 30b in the negative monopolar electrode green substrate 65b may have electrical insulating portions 32b or may not have any electrical insulating portions 32b. By using one of the negative electrode layer green substrates 30b as prepared in the negative electrode layer green substrate preparation step, the need for preparing another step is eliminated, which is an advantage in terms of process cost reduction as a whole.

(d) Laminated Body Assembly Step

This step is a step of alternately laminating the plurality of bipolar electrode green substrates 50b and the plurality of solid electrolyte layer green substrates 40b to form a bipolar electrode green substrate-solid electrolyte layer green substrate laminated body, laminating the positive monopolar electrode green substrate 61b on one end of the bipolar electrode green substrate-solid electrolyte layer green substrate laminated body in the lamination direction, and laminating the negative monopolar electrode green substrate 65b on the other end of the bipolar electrode green substrate-solid electrolyte layer green substrate laminated body in the lamination direction. In forming the all-solid-state battery green substrate laminated body 100b, it is preferred that it be pressurized in moderation by, for example, cold isostatic pressing (CIP) or warm isostatic pressing (WIP).

(All-Solid-State Battery Green Substrate Laminated Body Firing Step)

This step is a step of subjecting the all-solid-state battery green substrate laminated body 100b as a whole to a firing process to form the all-solid-state battery sinter-bonded body 100c in which the negative electrode layers 30c, the current collector layers 10c, the positive electrode layers 20c and the solid electrolyte layers 40c are sinter-bonded. The firing process preferably includes burning out the resin component contained in each green substrate (e.g., heating at 600° C. in an air atmosphere) and subsequently sintering the inorganic material component that configures each green substrate (e.g., 800° C. in a non-oxidizing atmosphere). Also, in order to facilitate the sinter-bonding between the layers, it is preferred that the all-solid-state battery green substrate laminated body 100b be pressurized in moderation during the firing process.

As described before, in the present invention, since the width of the electrical insulating portions 22b disposed in each positive electrode layer green substrate 20b and the width of the electrical insulating portions 32b disposed in each negative electrode layer green substrate 30b are set appropriately by calculating backward from the amount of firing shrinkage of each green substrate in the firing step, short-circuits between the positive electrode layer 20c and the negative electrode layer 30c that sandwiches each current collector 10c are prevented even after the firing step.

By following the steps described above, the all-solid-state battery sinter-bonded body 100c, which has a structure to prevent internal short-circuits and is capable of being fabricated by performing integral high-temperature firing on an entire bipolar laminated body, can be obtained. The all-solid-state-battery sinter-bonded body 100c is subsequently subjected to the external terminal connection step and the packaging step to become the bipolar laminated all-solid-state lithium-ion rechargeable battery.

(External Terminal Connection Step)

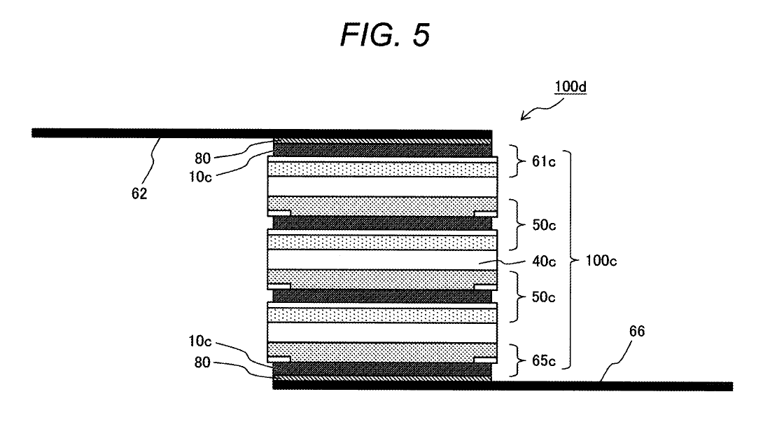

This step is a step of connecting an external terminal to the positive monopolar electrode 61c and the negative monopolar electrode 65c of the all-solid-state battery sinter-bonded body 100c. FIG. 5 is a longitudinal sectional schematic view of an all-solid-state battery structure obtained by the external terminal connection step according to the first embodiment of the invention. As shown in FIG. 5, a positive electrode external terminal 62 and a negative electrode external terminal 66 are connected to the current collector layer 10c of the positive monopolar electrode layer 61c and the current collector layer 10c of the negative monopolar electrode 65c, respectively, via a bonding layer 80 to form an all-solid-state battery structure 100d.

There are no particular limitations on the positive electrode external terminal 62 and the negative electrode external terminal 66. Preferred examples include highly conductive metals (e.g., copper, nickel, and aluminum). Also, there are no particular limitations on the material of the bonding layer 80. Preferred examples include materials that are capable of electrically satisfactorily bonding the highly conductive metal that configures the external terminals 62, 66 and the material that configure the current collector layers 10c (e.g., silver paste and solder).

(Packaging Step)

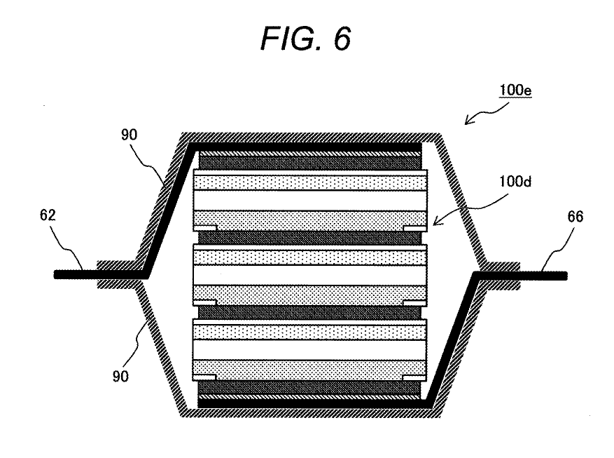

This step is a step of packaging the all-solid-state battery structure 100d for the protection and external insulation of the all-solid-state battery structure 100d. FIG. 6 is a longitudinal sectional schematic view of an all-solid-state battery obtained by the packaging step according to the first embodiment of the invention. As shown in FIG. 6, the all-solid-state battery structure 100d is sealed with an electrically insulating packaging material 90 (e.g., a resin material or a glass material) such that the positive electrode external terminal 62 and the negative electrode external terminal 66 partly protrude from inside the packaging to form a bipolar laminated all-solid-state lithium-ion rechargeable battery 100e.

By following the steps as described above, there can be obtained a bipolar laminated all-solid-state lithium-ion rechargeable battery according to the present invention.

### EXAMPLES

The present invention will be hereinafter described more specifically with examples. It is noted that the present invention is not limited to the examples herein.

[Fabrication of Bipolar Laminated all-Solid-State Lithium-Ion Rechargeable Battery of Example 1]

(1) Preparation of Slurry for Positive Electrode Active Material Portion Green Sheet

75 parts by mass of LiCoO₂ as a positive electrode active material, 25 parts by mass of Li₃BO₃ as a sintering additive, 1 part by mass of carbon black as a conductive additive, 10 parts by mass of ethyl cellulose (EC) as a resin binder, and 10 parts by mass of dioctyl phthalate (DOP) as a plasticizer were put into a ball mill and mixed well with 100 parts by mass of acetone as a solvent. The resultant solution mixture was defoamed under reduced pressure, and the solvent was partially volatilized to prepare a slurry for a positive electrode active material portion green sheet (viscosity: approximately 10,000 mPa·s).

(2) Preparation of Slurry for Electrical Insulating Portion Green Sheet

75 parts by mass of silica glass as an electrical insulating material, 25 parts by mass of silica gel as a sintering additive, 7 parts by mass of EC as a resin binder, and 10 parts by mass of DOP as a plasticizer were put into a ball mill and mixed well with 100 parts by mass of acetone as a solvent. The resultant solution mixture was defoamed under reduced pressure, and the solvent was partially volatilized to prepare a slurry for an electrical insulating portion green sheet (viscosity: approximately 10,000 mPa·s).

(3) Preparation of Slurry for Negative Electrode Active Material Portion Green Sheet

75 parts by mass of Li₄Ti₅O₁₂ as a negative electrode active material, 25 parts by mass of Li₃BO₃ as a sintering additive, 1 part by mass of carbon black as a conductive additive, 10 parts by mass of EC as a resin binder, and 10 parts by mass of DOP as a plasticizer were put into a ball mill and mixed well with 100 parts by mass of acetone as a solvent. The resultant solution mixture was defoamed under reduced pressure and the solvent was partially volatilized to prepare a slurry for a negative electrode active material portion green sheet (viscosity: approximately 10,000 mPa·s).

(4) Fabrication of Positive Electrode Layer Green Substrates and Negative Electrode Layer Green Substrates

Positive electrode layer green substrates and negative electrode layer green substrates were fabricated according to the procedure shown in FIG. 4A. First, the slurry for an electrical insulating portion green sheet as prepared above was formed into a parallel pair of electrical insulating portion green sheets (width: 10 mm, spacing: 40 mm, thickness: 20 μm) on a carrier sheet of polyethylene terephthalate (PET) by doctor blading using a 60 mm-wide doctor blade having a 10 mm cut-out portion on each end (see FIG. 4A (a)). Subsequently, the parallel pair of insulating portion green sheets were divided into two with the carrier sheet attached to them for use in positive electrode layers and negative electrode layers.

Next, using the slurry for a positive electrode active material portion green sheet as prepared above, a positive electrode active material portion green sheet was laminated so as to integrally embed the parallel pair of electrical insulating portion green sheets by doctor blading using a 60 mm-wide doctor blade to form a positive electrode layer green sheet (width: 60 mm, thickness: 70 μm) (see FIG. 4A (b)).

The positive electrode layer green sheet was then subjected to a stamp-out process such that the parallel pair of electrical insulating portion green sheets were disposed in a pair of opposite side regions of a quadrilateral (50 mm per side) and each had a width of 5 mm to fabricate positive electrode layer green substrates (length: 50 mm per side, thickness: 70 μm) (see FIG. 4A (c)).

Negative electrode layer green substrates (length: 50 mm per side, thickness: 70 μm) were fabricated from the slurry for an electrical insulating portion green sheet and the slurry for a negative electrode active material portion green sheet in the same manner as the positive electrode layer green substrates.

(5) Fabrication of Current Collector Layer Green Substrates

75 parts by mass of indium tin oxide (ITO) as a conductive material, 5 parts by mass of vanadium-based electrical conductive glass as a sintering additive, 23 parts by mass of silver as a conductive additive, 10 parts by mass of polyvinyl butyral (PVB) as a resin binder, and 12 parts by mass of DOP as a plasticizer were put into a ball mill and mixed well with 100 parts by mass of acetone as a solvent. The resultant solution mixture was defoamed under reduced pressure, and the solvent was partially volatilized to prepare a slurry for a current collector layer green sheet (viscosity: approximately 10,000 mPa·s).

The slurry for a current collector layer green sheet as prepared above was formed into a current collector layer green sheet (width: 60 mm, thickness: 50 μm) on a carrier sheet of PET by doctor blading using a 60 mm-wide doctor blade. Subsequently, the current collector layer green sheet was subjected to a stamp-out process to fabricate current collector layer green substrates (length: 50 mm per side, thickness: 50 μm).

(6) Fabrication of Solid Electrolyte Layer Green Substrates

75 parts by mass of Li₇La₃Zr₂O₁₂ as a solid electrolyte, 30 parts by mass of Li₃BO₃ as a sintering additive, 10 parts by mass of PVB as a resin binder, and 10 parts by mass of DOP as a plasticizer were put into a ball mill and mixed well with 100 parts by mass of acetone as a solvent. The resultant solution mixture was defoamed under reduced pressure and the solvent was partially volatilized to prepare a slurry for a solid electrolyte layer green sheet (viscosity: approximately 10,000 mPa·s).

The slurry for a solid electrolyte layer green sheet as prepared above was formed into a solid electrolyte layer green sheet (width: 60 mm, thickness: 100 μm) on a carrier sheet of PET by doctor blading using a 60 mm-wide doctor blade. Subsequently, the solid electrolyte layer green sheet was subjected to a stamp-out process to fabricate solid electrolyte layer green substrates (length: 50 mm per side, thickness: 100 μm).

(7) Fabrication of all-Solid-State Battery Green Substrate Laminated Body

The positive electrode layer green substrates, the negative electrode layer green substrates, the current collector layer green substrates, and the solid electrolyte layer green substrates as prepared above were laminated so as to form the structure shown in FIG. 2. Subsequently, the laminated body was pressure-bonded by warm isostatic pressing (temperature: 90° C., pressure: 40 MPa) to fabricate an all-solid-state battery green substrate laminated body.

(8) Fabrication of all-Solid-State Battery Sinter-Bonded Body

The all-solid-state battery green substrate laminated body as fabricated above was subjected to firing to fabricate an all-solid-state battery sinter-bonded body. First, the all-solid-state battery green substrate laminated body was sandwiched between two ceramics plates made of alumina and held at 600° C. for two hours in an air atmosphere to burn out the resin component and then held at 800° C. for two hours in a nitrogen gas atmosphere to sinter-bond the inorganic material component.

(9) Connection of External Terminals

A positive electrode external terminal and a negative electrode external terminal of nickel foil were pasted on the positive monopolar electrode and the negative monopolar electrode of the all-solid-state battery sinter-bonded body as fabricated above, respectively, via a bonding layer of silver paste. Subsequently, the sinter-bonded body attaching the external terminals was heated at 120° C. in an air atmosphere to secure the electrical bonding between the monopolar electrodes and the external terminals.

By following the steps as described above, the bipolar laminated all-solid-state lithium-ion rechargeable battery of Example 1 (for test evaluation) was fabricated. Incidentally, the all-solid-state battery structure was not packaged to allow easy observation of the battery after charge/discharge testing.

[Fabrication of Bipolar Laminated all-Solid-State Lithium-Ion Rechargeable Battery of Example 2]

The bipolar laminated all-solid-state lithium-ion rechargeable battery of Example 2 (for test evaluation) was fabricated in the same manner as Example 1 except that the configuration of its electrical insulating portions in positive electrode layer green substrates is that of the embodiment shown in FIG. 4B. Only the differences from Example 1 will be described hereinafter.

(10) Fabrication of Positive Electrode Layer Green Substrates and Negative Electrode Layer Green Substrates

Following the procedure shown in FIG. 4B, positive electrode layer green substrates were fabricated. First, the same slurry for an electrical insulating portion green sheet as Example 1 was formed into an electrical insulating portion sheet having 40 mm-square cut-out portions (overall width: 60 mm, thickness: 20 μm) on a PET carrier sheet by screen printing using a screen plate having a metal mesh (see FIG. 4B (a)).

Next, using the same slurry for a positive electrode active material portion green sheet as Example 1, a positive electrode active material portion green sheet was laminated so as to integrally embed the electrical insulating portion sheet having 40 mm-square cut-out portions by doctor blading using a 60 mm-wide doctor blade to form a positive electrode layer green sheet (width: 60 mm, thickness: 70 μm) (see FIG. B (b)).

Next, the positive electrode layer green sheet was then subjected to a stamp-out process such that the electrical insulating portion green sheet was disposed in the entire periphery of an outer edge region of a quadrilateral (50 mm per side) and had a width of 5 mm to fabricate positive electrode layer green substrates (length: 50 mm per side, thickness: 70 μm) (see FIG. 4B (c)).

As for the negative electrode layer green substrates, first, the same slurry for a negative electrode active material portion green sheet as Example 1 was formed into a negative electrode layer green sheet (width: 60 mm, thickness: 70 μm) by doctor blading using a 60 mm-wide doctor blade. No electrical insulating portion sheet was formed.

Next, the negative electrode layer green sheet was subjected to a stamp-out process to fabricate negative electrode layer green substrates (length: 50 mm per side, thickness: 70 μm). In other words, negative electrode layer green substrates without any electrical insulating portions were fabricated.

[Fabrication of Bipolar Laminated all-Solid-State Lithium-Ion Rechargeable Battery of Example 3]

The bipolar laminated all-solid-state lithium-ion rechargeable battery of Example 3 (for test evaluation) was fabricated in the same manner as Example 1 except that the configuration of its electrical insulating portions in the negative electrode layer green substrates was that of the embodiment shown in FIG. 4C, and each green substrate was circular in shape. Only the differences from Example 1 will be described hereinafter.

(11) Fabrication of Positive Electrode Layer Green Substrates and Negative Electrode Layer Green Substrates

Following the procedure shown in FIG. 4C, negative electrode layer green substrates were fabricated. First, the same slurry for an electrical insulating portion green sheet as Example 1 was formed into an electrical insulating portion sheet having 40 mm-diameter circular cut-out portions (overall width: 60 mm, thickness: 20 μm) on a PET carrier sheet by screen printing using a screen plate having a metal mesh (see FIG. 4C (a)).

Next, using the same slurry for a negative electrode active material portion green sheet as Example 1, a negative electrode active material portion green sheet was laminated so as to integrally embed the electrical insulating portion sheet having 40 mm-diameter circular cut-out portions by doctor blading using a 60 mm-wide doctor blade to form a negative electrode layer green sheet (width: 60 mm, thickness: 70 μm) (see FIG. 4C (b)).

Next, the negative electrode layer green sheet was then subjected to a stamp-out process such that the electrical insulating portion green sheet was disposed in the entire periphery of an outer edge region of a circle (diameter: 50 mm) and had a width of 5 mm to fabricate negative electrode layer green substrates (diameter: 50 mm, thickness: 70 μm) (see FIG. 4C (c)).

As for the positive electrode layer green substrates, first, the same slurry for a positive electrode active material portion green sheet as Example 1 was formed into a positive electrode layer green sheet (width: 60 mm, thickness: 70 μm) by doctor blading using a 60 mm-wide doctor blade. No electrical insulating portion sheet was formed.

Next, the positive electrode layer green sheet was subjected to a stamp-out process to fabricate positive electrode layer green substrates (diameter: 50 mm, thickness: 70 μm). In other words, positive electrode layer green substrates without any electrical insulating portions were fabricated.

(12) Fabrication of Current Collector Layer Green Substrates and Solid Electrolyte Layer Green Substrates

Current collector layer green substrates (diameter: 50 mm, thickness: 50 μm) and solid electrolyte layer green substrates (diameter: 50 mm, thickness: 100 μm) were fabricated in the same manner as Example 1 except that they were circular in shape after the stamp-out process (diameter: 50 mm).

[Fabrication of Bipolar Laminated all-Solid-State Lithium-Ion Rechargeable Battery of Comparative Example 1]

The bipolar laminated all-solid-state lithium-ion rechargeable battery of Comparative Example 1 (for test evaluation) was fabricated in the same manner as Example 1 except that it was fabricated with positive electrode layer green substrates and negative electrode layer green substrates without any electrical insulating portions.

[Fabrication of Bipolar Laminated all-Solid-State Lithium-Ion Rechargeable Battery of Comparative Example 2]

The bipolar laminated all-solid-state lithium-ion rechargeable battery of Comparative Example 2 (for test evaluation) was fabricated in the same manner as Example 1 except that a silver sheet (thickness: 50 μm) was used for its current collector layers.

[Evaluation of all-Solid-State Batteries]

The bipolar laminated all-solid-state lithium-ion rechargeable batteries of Examples 1 to 3 and Comparative Examples 1 and 2 as prepared above were subjected to constant-current constant-voltage charge/discharge testing (voltage range: 3.0 to 5.5 V, current density: 100 μA/cm²). The results showed that Examples 1 to 3 each exhibited the charge/discharge properties (capacitance and charge/discharge rate) as designed. This indicates that internal short-circuits were prevented while a sufficient electrical bondability between the layers that configured the rechargeable battery was secured. It also proves that the present invention is effective regardless of the configuration of electrical insulating portions or the shape of each layer.

By contrast, Comparative Example 1 exhibited a capacitance much smaller than designed. In a close observation of the rechargeable battery after the testing, internal short-circuits were found between positive electrode layers and negative electrode layers at the ends of some bipolar electrodes. From this it was inferred that Comparative Example 1, for which positive electrode layers and negative electrode layers without electrical insulating portions were used, exhibited a reduced capacitance due to internal short-circuits of the battery.

As for the rechargeable battery of Comparative Example 2, it was difficult to charge/discharge at the current density above. In a close observation of the rechargeable battery after the testing, exfoliation was found between some current collector layers and positive electrode layers or negative electrode layers. It was inferred that since in Comparative Example 2, for which a metal sheet was used as the current collector layers, the current collector layers and the other layers were significantly different in firing shrinkage behavior (the current collector layers, made of a metal sheet, expanded when the temperature was elevated and shrank to their original dimensions when the temperature was lowered, while the other layers, namely, the positive electrode layers, negative electrode layers, and solid electrolyte layers, shrank by firing from their previous forms, green substrates), interlaminar exfoliation occurred in the firing process, which resulted in poor electrical bondability between the layers.

The above embodiments are given for the purpose of detailed illustration and explanation only, and the invention is not intended to include all features and aspects of the embodiments described above. Then, the invention is not limited to the above described embodiments, and various modifications can be made. For example, a part of an embodiment may be replaced by a well-known technique, or added with a well-known technique. That is, various combinations with a well-known technique and modifications based on a well-known technique are possible without departing from the technical idea of the invention where appropriate.

What is claimed is:

1. A bipolar laminated all-solid-state lithium-ion rechargeable battery comprising:
a plurality of bipolar electrodes and
a plurality of solid electrolyte layers,
each bipolar electrode consisting of:
a current collector layer;
a positive electrode layer formed on one principal surface of the current collector layer; and
a negative electrode layer formed on the other principal surface of the current collector layer,
wherein when viewed from the lamination direction, each bipolar electrode and each solid electrolyte layer have a quadrilateral or circular shape, and the current collector layer has its outer edge inside the outer edge of the positive electrode layer and the negative electrode layer,
wherein at least one of the positive electrode layer and the negative electrode layer of each bipolar electrode is provided with at least one electrical insulating portion in a quadrilateral or circular outer edge region on the surface where the at least one of the positive electrode layer or the negative electrode layer is in contact with the current collector layer of the bipolar electrode,
wherein when each bipolar electrode is viewed from the lamination direction, the projection of the at least one electrical insulating portion configures the entire periphery of the outer edge of the quadrilateral or circular shape, and
wherein the plurality of bipolar electrodes and the plurality of solid electrolyte layers are alternately laminated and form a sinter-bonded body.

2. The bipolar laminated all-solid-state lithium-ion rechargeable battery according to claim 1,
wherein when viewed from the lamination direction, each bipolar electrode and each solid electrolyte layer have a quadrilateral shape, and
wherein the at least one electrical insulating portion of the positive electrode layer is disposed in one pair of opposite side regions of the quadrilateral shape, and the at least one electrical insulating portion of the negative electrode layer is disposed in the other pair of opposite side regions of the quadrilateral shape.

3. The bipolar laminated all-solid-state lithium-ion rechargeable battery according to claim 1,
wherein the current collector layer contains a main component consisting of at least one of a carbon-based material and an electrical conductive oxide,
wherein the positive electrode layer contains a main component consisting of a lithium transition metal composite oxide,
wherein the negative electrode layer contains a main component consisting of at least one of a carbon-based material, a lithium transition metal composite oxide, and a lithium transition metal composite nitride, and
wherein each solid electrolyte layer contains a main component consisting of a lithium composite oxide electrolyte.

4. The bipolar laminated all-solid-state lithium-ion rechargeable battery according to claim 2,
wherein the current collector layer contains a main component consisting of at least one of a carbon-based material and an electrical conductive oxide,
wherein the positive electrode layer contains a main component consisting of a lithium transition metal composite oxide,
wherein the negative electrode layer contains a main component consisting of at least one of a carbon-based material, a lithium transition metal composite oxide, and a lithium transition metal composite nitride, and
wherein each solid electrolyte layer contains a main component consisting of a lithium composite oxide electrolyte.

5. A method for manufacturing a bipolar laminated all-solid-state lithium-ion rechargeable battery, the bipolar laminated all-solid-state lithium-ion rechargeable battery comprising a plurality of bipolar electrodes and a plurality of solid electrolyte layers that are alternately laminated, each bipolar electrode consisting of a current collector layer, a positive electrode layer formed on one principal surface of the current collector layer, and a negative electrode layer formed on the other principal surface of the current collector layer, the method comprising:
a current collector layer green substrate preparation step of preparing a plurality of current collector layer green substrates by forming a current collector layer green sheet containing a main component of the current collector layer and a resin binder and by cutting the current collector layer green sheet into a quadrilateral or circular shape of predetermined dimensions;
a positive electrode layer green substrate preparation step of preparing a plurality of positive electrode layer green substrates by forming a positive electrode layer green sheet containing a main component of the positive electrode layer and a resin binder and by cutting the positive electrode layer green sheet into a quadrilateral or circular shape of predetermined dimensions;
a negative electrode layer green substrate preparation step of preparing a plurality of negative electrode layer green substrates by forming a negative electrode layer green sheet containing a main component of the negative electrode layer and a resin binder and by cutting the negative electrode layer green sheet into a quadrilateral or circular shape of predetermined dimensions;
a solid electrolyte layer green substrate preparation step of preparing a plurality of solid electrode layer green substrates by forming a solid electrolyte layer green sheet containing a main component of the solid electrolyte layer and a resin binder and by cutting the solid electrolyte layer green sheet into a quadrilateral or circular shape of predetermined dimensions;
an all-solid-state battery green substrate laminated body formation step of forming an all-solid-state battery green substrate laminated body by sequentially laminating the negative electrode layer green substrates, the current collector layer green substrates, the positive electrode layer green substrates, and the solid electrolyte layer green substrates as prepared in the steps above; and
an all-solid-state battery green substrate laminated body firing step of subjecting the all-solid-state battery green substrate laminated body as a whole to a firing process to form an all-solid-state battery sinter-bonded body in which the negative electrode layer, the current collector layer, and the positive electrode layer of each bipolar electrode and the solid electrolyte layers are sinter-bonded,
wherein when viewed from a lamination direction, each bipolar electrode and each solid electrolyte layer is formed to have a quadrilateral or circular shape, and the current collector layer of each bipolar electrode is configured to have its outer edge inside the outer edge of the positive electrode layer and the negative electrode layer of the bipolar electrode,
wherein at least one of the positive electrode layer and the negative electrode layer of each bipolar electrode is provided with at least one electrical insulating portion in a quadrilateral or circular outer edge region on the surface where the at least one of the positive electrode layer and the negative electrode layer is in contact with the current collector layer of the bipolar electrode,
wherein when each bipolar electrode is viewed from the lamination direction, the projection of the at least one electrical insulating portion of the bipolar electrode is made up of the entire periphery of the outer edge of the quadrilateral or circular shape,
wherein at least one of the positive electrode layer green substrate preparation step and the negative electrode layer green substrate preparation step is a step of forming an electrical insulating portion green sheet to become the at least one electrical insulating portion, then laminating at least one of a positive electrode active material portion green sheet and a negative electrode active material portion green sheet so as to integrally embed the electrical insulating portion green sheet therein to form at least one of the positive electrode layer green sheet and the negative electrode layer green sheet, and subsequently performing a cut-out process such that the at least one electrical insulating portion to be cut out from the electrical insulating portion green sheet is disposed in the quadrilateral or circular outer edge region,
wherein the all-solid-state battery green substrate laminated body formation step comprises a step of forming a plurality of bipolar electrode green substrates by laminating each positive electrode layer green substrate on one principal surface of each current collector layer green substrate and laminating each negative electrode layer green substrate on the other principal surface of the current collector layer green substrate, and
wherein the bipolar electrode green substrate formation step is a step of laminating each positive electrode layer green substrate and each negative electrode layer green substrate on each current collector layer green substrate such that the at least one electrical insulating portion of at least one of the positive electrode layer green substrate and the negative electrode layer green substrate faces the current collector layer green substrate, and when each bipolar electrode green substrate is viewed from the lamination direction, the projection of the at least one electrical insulating portion of the bipolar electrode is made up of the entire periphery of the outer edge of the quadrilateral or circular shape.

6. The method for manufacturing a bipolar laminated all-solid-state lithium-ion rechargeable battery according to claim 5,
wherein when viewed from the lamination direction, each bipolar electrode and each solid electrolyte layer has a quadrilateral shape, and
wherein the bipolar electrode green substrate formation step is a step of laminating each of the plurality of the positive electrode layer green substrates and each of the plurality of the negative electrode layer green substrates on each of the plurality of current collector layer green substrates such that when viewed from the lamination direction, the at least one electrical insulating portion of the positive electrode layer green substrate is disposed in one pair of opposite side regions of the quadrilateral shape, and the at least one electrical insulating portion of the negative electrode layer green substrate is disposed in the other pair of opposite side regions of the quadrilateral shape.

7. The method for manufacturing a bipolar laminated all-solid-state lithium-ion rechargeable battery according to claim 5, wherein the current collector layer green substrate preparation step is a step of adjusting a current collector layer slurry to form the current collector layer green sheet such that a shrinkage amount of the plurality of current collector layer green substrates is greater than those of the plurality of positive electrode layer green substrates and the plurality of negative electrode layer green substrates in the all-solid-state battery green substrate laminated body firing step.

8. The method for manufacturing a bipolar laminated all-solid-state lithium-ion rechargeable battery according to claim 6, wherein the current collector layer green substrate preparation step is a step of adjusting a current collector layer slurry to form the current collector layer green sheet such that a shrinkage amount of the plurality of current collector layer green substrates is greater than those of the plurality of positive electrode layer green substrates and the plurality of negative electrode layer green substrates in the all-solid-state battery green substrate laminated body firing step.

9. The method for manufacturing a bipolar laminated all-solid-state lithium-ion rechargeable battery according to claim 5, wherein the all-solid-state battery green substrate laminated body formation step further comprises:
a positive monopolar electrode green substrate formation step of laminating a positive electrode layer green substrate on one principal surface of a current collector layer green substrate to form a positive monopolar electrode green substrate;
a negative monopolar electrode green substrate formation step of laminating a negative electrode layer green substrate on one principal surface of a current collector layer green substrate to form a negative monopolar electrode green substrate; and
a laminated body assembly step of alternately laminating the plurality of bipolar electrode green substrates and the plurality of solid electrolyte layer green substrates to form a bipolar electrode green substrate-solid electrolyte layer green substrate laminated body, laminating the positive monopolar electrode green substrate on one end of the bipolar electrode green substrate-solid electrolyte layer green substrate laminated body in the lamination direction, and laminating the negative monopolar electrode green substrate on the other end of the bipolar electrode green substrate-solid electrolyte layer green substrate laminated body in the lamination direction.

10. The method for manufacturing a bipolar laminated all-solid-state lithium-ion rechargeable battery according to claim 6, wherein the all-solid-state battery green substrate laminated body formation step further comprises:
a positive monopolar electrode green substrate formation step of laminating a positive electrode layer green substrate on one principal surface of a current collector layer green substrate to form a positive monopolar electrode green substrate;
a negative monopolar electrode green substrate formation step of laminating a negative electrode layer green substrate on one principal surface of a current collector layer green substrate to form a negative monopolar electrode green substrate; and
a laminated body assembly step of alternately laminating the plurality of bipolar electrode green substrates and the plurality of solid electrolyte layer green substrates to form a bipolar electrode green substrate-solid electrolyte layer green substrate laminated body, laminating the positive monopolar electrode green substrate on one end of the bipolar electrode green substrate-solid electrolyte layer green substrate laminated body in the lamination direction, and laminating the negative monopolar electrode green substrate on the other end of the bipolar electrode green substrate-solid electrolyte layer green substrate laminated body in the lamination direction.

11. The method for manufacturing a bipolar laminated all-solid-state lithium-ion rechargeable battery according to claim 7, wherein the all-solid-state battery green substrate laminated body formation step further comprises:
a positive monopolar electrode green substrate formation step of laminating a positive electrode layer green substrate on one principal surface of a current collector layer green substrate to form a positive monopolar electrode green substrate;
a negative monopolar electrode green substrate formation step of laminating a negative electrode layer green substrate on one principal surface of a current collector layer green substrate to form a negative monopolar electrode green substrate; and
a laminated body assembly step of alternately laminating the plurality of bipolar electrode green substrates and the plurality of solid electrolyte layer green substrates to form a bipolar electrode green substrate-solid electrolyte layer green substrate laminated body, laminating the positive monopolar electrode green substrate on one end of the bipolar electrode green substrate-solid electrolyte layer green substrate laminated body in the lamination direction, and laminating the negative monopolar electrode green substrate on the other end of the bipolar electrode green substrate-solid electrolyte layer green substrate laminated body in the lamination direction.

12. The method for manufacturing a bipolar laminated all-solid-state lithium-ion rechargeable battery according to claim 8, wherein the all-solid-state battery green substrate laminated body formation step further comprises:
a positive monopolar electrode green substrate formation step of laminating a positive electrode layer green substrate on one principal surface of a current collector layer green substrate to form a positive monopolar electrode green substrate;
a negative monopolar electrode green substrate formation step of laminating a negative electrode layer green substrate on one principal surface of a current collector layer green substrate to form a negative monopolar electrode green substrate; and
a laminated body assembly step of alternately laminating the plurality of bipolar electrode green substrates and the plurality of solid electrolyte layer green substrates to form a bipolar electrode green substrate-solid electrolyte layer green substrate laminated body, laminating the positive monopolar electrode green substrate on one end of the bipolar electrode green substrate-solid electrolyte layer green substrate laminated body in the lamination direction, and laminating the negative monopolar electrode green substrate on the other end of the bipolar electrode green substrate-solid electrolyte layer green substrate laminated body in the lamination direction.

13. The method for manufacturing a bipolar laminated all-solid-state lithium-ion rechargeable battery according to claim 5,
wherein the current collector layer contains a main component consisting of at least one of a carbon-based material and an electrical conductive oxide,
wherein the positive electrode layer contains a main component consisting of a lithium transition metal composite oxide,
wherein the negative electrode layer contains a main component consisting of at least one of a carbon-based material, a lithium transition metal composite oxide, and a lithium transition metal composite nitride, and
wherein each solid electrolyte layer contains a main component consisting of a lithium composite oxide electrolyte.

14. The method for manufacturing a bipolar laminated all-solid-state lithium-ion rechargeable battery according to claim 6,
wherein the current collector layer contains a main component consisting of at least one of a carbon-based material and an electrical conductive oxide,
wherein the positive electrode layer contains a main component consisting of a lithium transition metal composite oxide,
wherein the negative electrode layer contains a main component consisting of at least one of a carbon-based material, a lithium transition metal composite oxide, and a lithium transition metal composite nitride, and
wherein each solid electrolyte layer contains a main component consisting of a lithium composite oxide electrolyte.

15. The method for manufacturing a bipolar laminated all-solid-state lithium-ion rechargeable battery according to claim 7,
wherein the current collector layer contains a main component consisting of at least one of a carbon-based material and an electrical conductive oxide,
wherein the positive electrode layer contains a main component consisting of a lithium transition metal composite oxide,
wherein the negative electrode layer contains a main component consisting of at least one of a carbon-based material, a lithium transition metal composite oxide, and a lithium transition metal composite nitride, and
wherein each solid electrolyte layer contains a main component consisting of a lithium composite oxide electrolyte.

16. The method for manufacturing a bipolar laminated all-solid-state lithium-ion rechargeable battery according to claim 8,
wherein the current collector layer contains a main component consisting of at least one of a carbon-based material and an electrical conductive oxide,
wherein the positive electrode layer contains a main component consisting of a lithium transition metal composite oxide,
wherein the negative electrode layer contains a main component consisting of at least one of a carbon-based material, a lithium transition metal composite oxide, and a lithium transition metal composite nitride, and
wherein each solid electrolyte layer contains a main component consisting of a lithium composite oxide electrolyte.

17. The method for manufacturing a bipolar laminated all-solid-state lithium-ion rechargeable battery according to claim 9,
wherein the current collector layer contains a main component consisting of at least one of a carbon-based material and an electrical conductive oxide,
wherein the positive electrode layer contains a main component consisting of a lithium transition metal composite oxide,
wherein the negative electrode layer contains a main component consisting of at least one of a carbon-based material, a lithium transition metal composite oxide, and a lithium transition metal composite nitride, and
wherein each solid electrolyte layer contains a main component consisting of a lithium composite oxide electrolyte.

18. The method for manufacturing a bipolar laminated all-solid-state lithium-ion rechargeable battery according to claim 10,
wherein the current collector layer contains a main component consisting of at least one of a carbon-based material and an electrical conductive oxide,
wherein the positive electrode layer contains a main component consisting of a lithium transition metal composite oxide,
wherein the negative electrode layer contains a main component consisting of at least one of a carbon-based material, a lithium transition metal composite oxide, and a lithium transition metal composite nitride, and
wherein each solid electrolyte layer contains a main component consisting of a lithium composite oxide electrolyte.

19. The method for manufacturing a bipolar laminated all-solid-state lithium-ion rechargeable battery according to claim 11,
wherein the current collector layer contains a main component consisting of at least one of a carbon-based material and an electrical conductive oxide,
wherein the positive electrode layer contains a main component consisting of a lithium transition metal composite oxide,
wherein the negative electrode layer contains a main component consisting of at least one of a carbon-based material, a lithium transition metal composite oxide, and a lithium transition metal composite nitride, and
wherein each solid electrolyte layer contains a main component consisting of a lithium composite oxide electrolyte.

20. The method for manufacturing a bipolar laminated all-solid-state lithium-ion rechargeable battery according to claim 12,
wherein the current collector layer contains a main component consisting of at least one of a carbon-based material and an electrical conductive oxide,
wherein the positive electrode layer contains a main component consisting of a lithium transition metal composite oxide,
wherein the negative electrode layer contains a main component consisting of at least one of a carbon-based material, a lithium transition metal composite oxide, and a lithium transition metal composite nitride, and
wherein each solid electrolyte layer contains a main component consisting of a lithium composite oxide electrolyte.
